(19) United States
(12) Patent Application Publication
(10) Pub. No.: US 2015/0066797 A1
(43) Pub. Date: Mar. 5, 2015

(54) SYSTEM AND METHOD FOR ENHANCING DELIVERY SECURITY AND PREVENTING FRAUD

(71) Applicants: Christopher Scott Outwater, Carpinteria, CA (US); William Gibbens Redmann, Glendale, CA (US)

(72) Inventors: Christopher Scott Outwater, Carpinteria, CA (US); William Gibbens Redmann, Glendale, CA (US)

(21) Appl. No.: 14/017,491

(22) Filed: Sep. 4, 2013

(51) Int. Cl. G06Q 10/08

(52) U.S. Cl. CPC G06Q 10/083; G06Q 10/0833
USPC 705/333; 705/330

(57) ABSTRACT

A system and method that authenticates a shipment to a particular address. A cellular telephone application allows total control of who can be the recipient. The telephone number of a particular cellphone is associated by the carrier with the tracking number of a parcel. The carrier, upon receipt of the parcel for shipping sends an authorization code, which may comprise an expiration date, and/or biometric information, and which may be presented as an electronic barcode image, or presented in other ways (e.g., Bluetooth, infra-red communication) by an application in the telephone. The telephone can securely store this information in its memory, in association with the tracking number. To receive or pickup the parcel, the recipient must present this authentication code (e.g., as a barcode) with their telephone, for scanning by the carrier's delivery agent. Only after authentication code is verified is the parcel released.

This invention claims priority under 35 U.S.C. 119, to U.S. Provisional Patent Application No. 61/696,807, which was filed Sep. 5, 2013, by the same inventors.

### FIELD OF THE INVENTION

The present invention relates generally to the field of consumer fraud and more particularly to a system and method for preventing credit card fraud (or any other type of fraud) by preventing shipments of merchandise to an unauthenticated recipient.

### BACKGROUND

Credit card theft and other fraud is at an all time high, especially since the coming of the Internet. Credit card numbers are obtained illegally by a variety of means including hacking into merchants' databases, or fraudulently soliciting them from consumers. A favorite trick of the credit card number thief is to order expensive merchandise online using the stolen card number and correct supporting information such as consumer billing address, and then specifying a different shipping address; an address that is under the control of the thief. Some merchants are refusing to ship to any address but the billing address of the card; however, this is a disadvantage to the merchant since many legitimate sales may be lost. It is also very annoying to the legitimate customer who needs to receive the item at a different address or wishes to ship a gift or the like to a third party. Hence, most online merchants accept and will continue to accept a shipping address that is different from the billing address. It would be very advantageous to have a system and method where merchants and anyone else who desired shipping security could safely ship to a particular shipping address and be confident that the item can only be retrieved by an authorized person or that thieves could not ship and pick up the item at an unauthorized address.

### SUMMARY OF THE INVENTION

The present invention relates to a system and method that authenticates shipping of merchandise and any other item to a particular address including to an address different from a billing address associated with a credit card. A cellular telephone application along with a small change in the way carriers handle shipping allows total control of who can be the recipient of a shipment. Since, all carriers use tracking numbers (or have the capability to do so such as the U.S. Postal Service, UPS, FedEx), only a small change to the carrier's current process allows entry of a cellular telephone number by the person shipping, such as a shipping merchant. This telephone number becomes associated by the carrier with the tracking number of the item. In many present-day shipping procedures, a telephone number is already collected and associated with a shipment. The carrier, upon receipt of the parcel for shipping, can send a dated barcode to the application of the present invention in the telephone. The telephone can securely store this barcode in memory, along with the tracking number. In order to receive or pickup the parcel at any shipping address, the authorized consumer must display this barcode on their telephone for scanning by the carrier's delivery agent, or present a code in some form from the telephone. Only after authentication of the code is the item released. The stored barcode can be password or otherwise protected in the telephone so that if the phone is lost, the barcode is inaccessible. In one embodiment of the present invention, the barcode can also be delivered to the telephone of a third party by specification of the authorized consumer, or in some cases, the code can be passed from one telephone to another. This is useful if the item is to be delivered to someone such as a fellow office worker, who is designated by the valid recipient, and authorized by the valid recipient. Further, a chain of custody for the code can be tracked when forwarded or otherwise sent to another party, the code can be changed, based on the number it was sent to. Additionally, the barcode, or other code, can be dated, and become obsolete after a certain number of days, hours or minutes, if not used. Typically, once a code is used, it becomes obsolete and is not valid for subsequent deliveries.

We like this because it is cheap. No new hardware, just software. Very similar to asking for your zipcode when getting gas. Added security for very little cost.

### DESCRIPTION OF THE FIGURES

Attention is now drawn to the several drawings that illustrate features of the present invention, in which:

FIG. 1 shows a prior art method of online ordering and receiving merchandise, as used by fraudsters;

FIG. 2 shows a block diagram of one example embodiment for an improved delivery process; and,

FIG. 3 shows a flowchart of the secure receipt process in a particular embodiment of the application in a cellular telephone.

Several drawings and illustrations have been presented to aid in understanding the present invention. The scope of the present invention is not limited to what is shown in the figures.

### DETAILED DESCRIPTION OF THE INVENTION

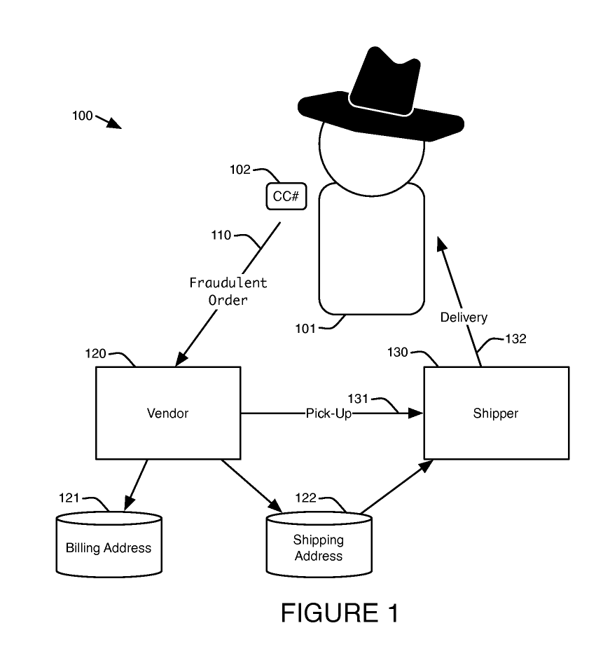

FIG. 1 is an example transaction 100 showing present way items are ordered online and delivered by a carrier. A fraudster 101 illegally obtains a credit card number 102 and a billing address 121. He or she places a fraudulent order 110 with an online vendor 120 using this card information. A shipping address 122 different from the billing address, and totally under the control of the fraudster 101, is specified as part of the ordering process. The vendor 120 fills the order, bills the card 102 using the billing address 121, with the order being picked up 131 by the shipper 130, often on the same day, for prompt delivery 132 to the shipping address 122.

Even if the card owner detects the illegal charge, it is usually impossible to prevent the shipment in time since the owner typically calls the card issuing company who may then open an investigation. By the time that happens, the merchandise has arrived at the shipping address and is gone. Carriers such as United Parcel Service (UPS) and Federal Express (FedEx) usually only require a signature of the correct consumer name (and sometimes any signature) to complete delivery. The thief or his agent can usually supply this. Many mail drop services can sign for the consumer for the United States Postal Service (USPS), UPS, FedEx and other carriers.

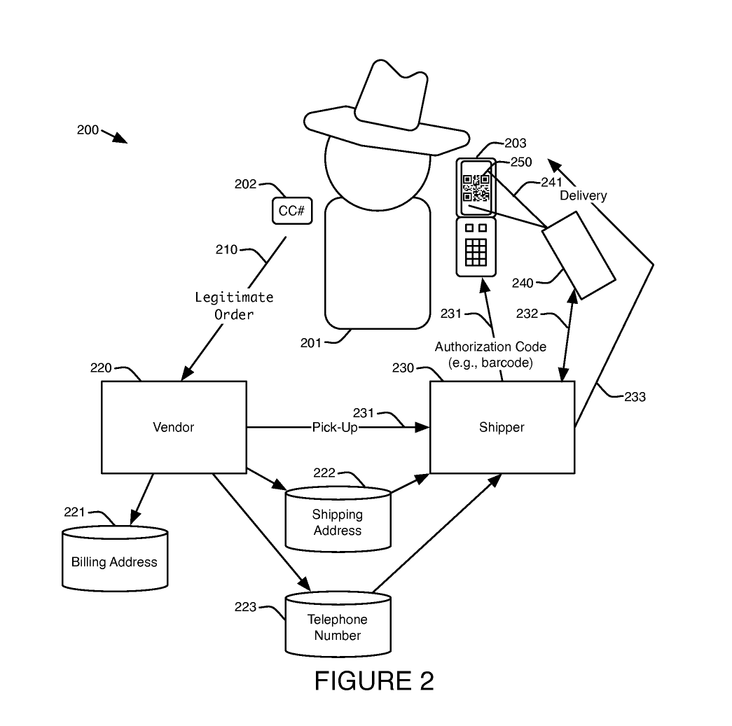

FIG. 2 shows an example embodiment of an improved transaction 200 of the present invention that stops this practice. Here too, the consumer 201 supplies a credit card number 202, billing address 221, and shipping address 222, as before, but also supplies a cellphone number 223 to the vendor 220 as part of legitimate order 210. The shipper 230 (also referred to as the carrier), generates a tracking number for the shipment (well known in the art), and also generates an authorization code 231, for example as a electronic barcode image 250, which may both be sent to the cell phone 203 of the consumer 201 identified by the telephone number 223. The authorization code and tracking number may be received by a dedicated application running on the specified telephone. The authorization code 231 may further include or be associated with an expiration date and/or time. In an alternative embodiment, the authorization code 231 and the associated tracking information may be sent to the phone via email or multimedia messaging service (MMS), in which case a general purpose email or messaging application runs on the cell phone 203. The tracking number is used in the ordinary way, to inquire as to the status and expected delivery schedule for the corresponding parcel.

The authorization code 231 (or electronic barcode image 250) does not necessarily have to be sent to the consumer's telephone; rather, it could also be sent to any telephone specified by the consumer 201 (or other shipping originator), so as to authorize a telephone belonging to a third party recipient. In some embodiments, the authorization code 231 sent to a particular telephone 203 may be based on or otherwise associated with the particular telephone.

In some embodiments, an authorization code 231 may be sent to a computer and the corresponding barcode printed for presentation to the delivery agent, if business policy allows. However, presentation of the authorization code (e.g., as electronic barcode image 250) with a smartphone 203 is preferable.

However sent, the recipient 201 (or other recipient) authorized by the sender/buyer/vendor receives the authorization code 231 on the recipient's telephone 203, as this will be required during delivery 233 to receive the parcel (or to pick up the parcel, if held at a facility of the shipper). The delivery agent (or, in the alternative, a clerk at a pick-up facility) employs a scanner 240 to read and verify authorization code 231 from cell phone 203 (as shown by the field-of-view 241 of scanner 240) before delivery 233 of the corresponding parcel.

Thus, if fraudster 101 were trying to pull off a scam, he would also need access to the recipient's cell phone 203 (and potentially the pin to access the cell phone) so as to retrieve and display the barcode 250 to present to the delivery agent, which is not likely.

Under some business policies, there may be an extra shipping charge for this service. The vendor 220 may charge the consumer 201, and then pay the carrier 230. Alternatively, if a sender (not shown) desired secure delivery of a parcel, the fee could be paid to the carrier 230 by that sender, no intermediate vendor need be involved, as in the case where a company or government agent wishes to ensure that a package is delivered to the proper, authorized person to which the valid authorization code or barcode would be provided.

When delivery is attempted, or when a customer attempts a pickup at a shipper facility (the pickup point), the authorized recipient 201 retrieves the authorization code from the telephone 203, for example as electronic barcode image 250. In some embodiments, the authorized recipient 201 must enter a password into the telephone 203 to retrieve and display barcode 250. If a valid authorization code is presented, the delivery agent completes the delivery 233 and the delivery attempt is successful, otherwise the delivery attempt fails and the parcel is not delivered.

In a dedicated cell phone application for managing deliveries, a menu of options can be presented that includes a list of all pending tracking numbers, which may further include any that have become obsolete. The menu may also provide the ability to cancel particular tracking numbers (and their associated barcodes), even if not retrieved. The application displays an electronic barcode image on the screen of cell phone 203 (or otherwise presents the authorization code in the appropriate manner, discussed further below) in response to the associated tracking number being selected, or clicked on the phone's display.

When multiple deliveries are expected, it may be necessary to match the tracking number with the barcode. In some embodiments, the smartphone application could scan a barcode (not shown) on the delivery agent's device 240 in order to obtain the right tracking number in the application, for which there is either a match or not. The would-be recipient's cell phone 203 must then recall and display the corresponding barcode to allow successful delivery 233.

The barcode 250 can be scanned 241 by a device 240 of the carrier's agent for authentication against the carrier's database through connection 232. (Device 240 may have been previously obtained an expected barcode value, or the expected barcode value may be dynamically retrieved). This takes place before the parcel is handed over. Generally, once a barcode 250 has been scanned by the carrier, it is marked as “used” (or “delivered”) along with the tracking number in the carrier's database, and once taken down from the telephone screen, it will normally be deleted from the telephone. In some embodiments of the invention, the barcode can be restored, even after display, for example to recover from the case where the barcode was brought up by mistake (e.g., the wrong code was retrieved before the correct one).

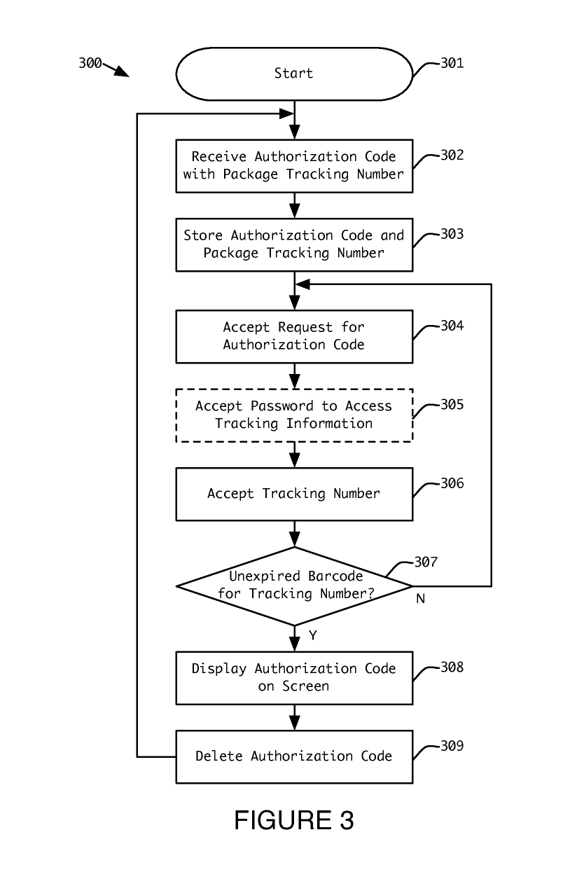

FIG. 3 shows one example flowchart for authorization code management process 300 performed by a cellular telephone application, which suitable for use in the improved delivery process taught herein. Authorization code management process 300 begins at 301 where after, at any time, a new tracking number and authorization code can be received 302 and stored 303 in the memory of the telephone. Steps 302, 303 can occur more than once in conjunction with different shipments. Subsequently, at any time, the phone's owner 201 can request 304 a particular barcode. In the preferred embodiment, access to stored barcodes is restricted by password or some other security method, which must be entered at step 305. For example, the authorization code may be stored in memory in encrypted form, and the password required for decryption. In other embodiments, the password is not required, for which reason step 305 is shown as optional (i.e., illustrated in FIG. 3 with a dotted outline). A particular tracking number can be entered in step 306, which, as described above, may include the tracking number being selected from a list or clicked on the screen. Upon a particular stored tracking number being entered or selected in step 306, a determination is made at step 307 as to whether an unexpired authentication code is associated with the tracking number. If so, process 300 continues at step 308 the associated barcode can be displayed graphically on the telephone's display for scanning (or the stored code can be presented to the carrier), otherwise the process returns to step 304 awaiting another request. Once used, a code or barcode can be deleted from the telephone's storage at step 309.

In some cases, an authorized originator may desire to transfer the stored authorization code or barcode and the associated tracking number to another telephone. In the preferred embodiment, for security reasons, the authorization code or barcode will only reside on one telephone at a time. In other words, the transferring telephone will normally delete the barcode and tracking number upon transferring them to another authorized telephone. In other embodiments, multiple copies of the authorization code (or barcode) and tracking number are allowed on different authorized telephones simultaneously. This can be valuable if, for example, the owner of the first phone is not sure whether he will pick up the item or whether it will be the owner of the second telephone. Once the delivery 233 is made, all phones apps will be updated via wireless communication to indicate successful delivery and to delete the now-expended authorization codes.

In some embodiments of the invention, the authorization code, the electronic barcode image, or associated data can be modified or augmented upon each transfer to a subsequent telephone. This data can be read by the carrier's agent so that the agent expects a different party to pick up the item than the previously specified party.

For maximum security, as may be necessary in some embodiments, the barcode can contain the identity of the person receiving the package. If a one-dimensional barcode is too small to contain this additional data, a two-dimensional or multi-dimensional barcode can be used. Any type of barcode or any other visual graphic presentation that can be displayed on the display of a cellular telephone is within the scope of the present invention and is meant by the present use of the word “barcode”. In addition, any type of code, digit, text, set of characters or number, plain or encrypted, via Bluetooth, or infra-red communication port, or the like, that can be stored in a telephone and rendered to the carrier or delivery person or their equipment (e.g., scanner 240) by any manner is within the scope of the present application and is being referred to in the present application as a “barcode”. In this case, the code might not be displayed on the telephone screen, but conveyed electronically from the telephone 203 to the carrier device 204 at the point of delivery (prescribed by the shipping address 222) or at a pickup point (e.g., carrier facility).

A maximum security embodiment of the invention allows only the originally specified telephone 203 and the original authorization code 231 (e.g., displayed as barcode 250) to be used. In this case, in order to receive the item from the carrier, the recipient 201 must have the right telephone 203, tracking number, and barcode 250 displayed on the telephone 203. This could be used when the originating shipper absolutely wants to prohibit transfers.

In some embodiments, another particular security feature is a call-back (not shown) from the correct telephone 203 to the carrier 230 in addition to displaying or presenting the proper code 231 or barcode 250. This would further ensure that correct person is presenting the information.

Optionally, for some high security uses, biometric identification such as an electronic fingerprint of the person to accept (i.e., receive or pick-up) the item could be included in the code 231 or barcode 250. This would be entered into the system by the originator, such as the consumer 201 using a fingerprint input device (not shown) at the time of purchase and verified through the carrier agent's device 240. Any type of biometric identification is within the scope of the present invention.

In some embodiments, the lifetime of the barcode or authorization code can be specified by either the original consumer or by the carrier for a particular delivery, rather than being generated indefinitely. Since such barcodes have a limited, programmable lifetime, either the consumer or the carrier could enter the delivery date or time so that the barcode can be sent the day before, the same morning, an hour ahead, five minutes ahead, and so on, according to policy or preferences. The lifetime of an authorization code or barcode may chosen depending upon the security requirements for a particular delivery.

The shipper 203 (and hence the vendor 220) could add a surcharge for the extra security provided by the present invention.

In summary, the present invention provides considerably enhanced security in the delivery of packages or items shipped. It can be used in any shipping context, and does not require an online purchase. It is particularly useful to assure proper delivery of sensitive items, which may be sent by the government, attorneys, doctors and hospitals, and by anyone needing enhanced security in shipping that can be resolved by better demonstrating a would-be recipient is duly authorized.

Several descriptions and illustrations have been presented to aid in understanding the present invention. One with skill in the art will realize that numerous changes and variations can be made without departing from the spirit of the invention. Each of these changes and variations is within the scope of the present invention.

We claim:

1. A method for enhancing the security of parcel delivery comprising:
a) receiving on a cellular telephone an authorization code related to a particular shipment;
b) storing in a memory of the cellular telephone the authorization;
c) accepting with said cellular telephone a request for the authorization code related to the shipment;
d) retrieving the authorization code from said memory of the said cellular telephone in response to the request;
e) presenting the authorization code with said cellular telephone to one of a carrier, a carrier's agent, and a carrier's agent's device to allow delivery of the shipment.

2. The method of claim 1 wherein the authorization code comprises an expiration date and wherein step d) is further in response to the authorization code being unexpired.

3. The method of claim 1 wherein the authorization code is unique.

4. The method of claim 1 wherein the authorization code is based on the telephone number of the cellular telephone.

5. The method of claim 1 wherein the authorization code is associated with the telephone number of the cell phone.

6. The method of claim 1 wherein in step c) presenting the authorization code is as a electronic barcode image on a screen of the cellular telephone.

7. The method of claim 1 wherein in step c) presenting the authorization code with the cellular telephone is by wireless communication.

8. The method of claim 7 wherein the wireless communication is Bluetooth.

9. The method of claim 7 wherein the wireless communication is infra-red communication.

10. The method of claim 1 wherein the request comprises a tracking number for the shipment.
